(19) United States
(12) Patent Application Publication
(10) Pub. No.: US 2026/0349276 A1
(43) Pub. Date: Nov. 5, 2026

(54) METHOD OF TREATING A PATIENT POPULATION WITH PRESBYOPIA AND ASTIGMATISM USING A MULTIFOCAL TORIC LENS

(71) Applicant: Johnson & Johnson Vision Care, Inc., Jacksonville, FL (US)

(72) Inventors: Ross FRANKLIN, Jacksonville, FL (US); Giovanna O. Olivares-Petito, Jacksonville, FL (US); Philippe F. JUBIN, Fernandina Beach, FL (US)

(73) Assignee: Johnson & Johnson Vision Care, Inc., Jacksonville, FL (US)

(21) Appl. No.: 19/658,013

(22) Filed: Apr. 24, 2026

Related U.S. Application Data
(60) Provisional application No. 63/798,503, filed on May 1, 2025.
(60) Provisional application No. 63/798,689, filed on May 2, 2025.

(51) Int. Cl. G02C 7/02; G02C 7/04

(52) U.S. Cl. CPC G02C 7/027; G02C 7/041; G02C 2202/06

(57) ABSTRACT

A method of treating a patient within a patient population having presbyopia and astigmatism comprises identifying a spherical power and a cylinder power refraction of a patient within the patient population; applying a vertex correction to a spherical power and a cylinder power of the multifocal toric lens; and providing the multifocal toric contact lens to the patient within the patient population, wherein the magnitude of the patient's cylinder refraction is within the range from approximately 0.25 D less than the cylinder power of the multifocal toric contact lens, to approximately 0.75 D more than the cylinder power of the multifocal toric contact lens.

### CROSS-REFERENCE TO RELATED APPLICATIONS

This application claims benefit of priority under 35 U.S.C. § 119 to, prior filed U.S. Provisional Patent Application No. 63/798,689, filed May 2, 2025 (Attorney Docket No.: 254640.000017 (VTN6207USPSP2)), and to prior filed U.S. Provisional Patent Application No. 63/798,503, filed May 1, 2025 (Attorney Docket No.: 254640.000016 (VTN6207USPSP1)). The entire contents of which are hereby incorporated by reference as if set forth in full herein.

### TECHNICAL FIELD

Disclosed herein are methods of treating a patient within a patient population having presbyopia and astigmatism with a multifocal toric contact lens.

### BACKGROUND

Multifocal contact lenses are designed to address presbyopia, a condition that affects the eye's ability to focus on close objects, typically occurring with age. These lenses can incorporate multiple focal points, allowing wearers to see clearly at various distances, near, intermediate, and far, without needing separate reading glasses.

Toric lenses are designed to address astigmatism and correction of 0.75 D of astigmatism is common in single vision contact lens wearers, as this usually provides a worthwhile improvement in vision. Most commercially available toric soft contact lenses have a lowest available cylinder correction of 0.75 D and are available in 0.50 D increments. Prior research shows that 0.75 D of uncorrected cylinder can cause more than one line (0.1 log MAR) reduction of visual acuity (VA), although the effect may be reduced somewhat by adaptation to the blur.

### BRIEF SUMMARY

One aspect of the present disclosure relates to a method of treating a patient within a patient population having presbyopia and astigmatism. The method comprises identifying a spherical power and a cylinder power refraction of a patient within the patient population; applying a vertex correction to a spherical power and a cylinder power of the multifocal toric lens; and providing the multifocal toric contact lens to the patient within the patient population, wherein the magnitude of the patient's cylinder refraction is within the range from approximately 0.25 D less than the cylinder power of the multifocal toric contact lens, to approximately 0.75 D more than the cylinder power of the multifocal toric contact lens.

Correction of 0.75 D of astigmatism is common in single vision contact lens wearers, but less so for multifocal contact lens (MFCL) wearers. To examine the consequences of this, binocular visual acuity (VA) of MFCL wearers with 0.75 D of uncorrected astigmatism was compared to wearers with lower amounts of astigmatism.

### BRIEF DESCRIPTION OF DRAWINGS

The foregoing and other objects and advantages will be apparent upon consideration of the following detailed description, taken in conjunction with the accompanying drawings, in which like reference characters refer to like parts throughout, and in which:

FIG. 1 illustrates high luminance, high contrast visual acuity (log MAR) of the patients by cylinder refraction group (error bars show +/−1 SD).

FIG. 2 illustrates low luminance, high contrast visual acuity (log MAR) of the patients by cylinder refraction group (error bars show +/−1 SD).

FIG. 3 illustrates the proportion of favorable (top two box) responses to subjective vision questions by cylinder refraction group.

FIG. 4 illustrates the modelled through-focus high luminance visual acuity (in-10 log MAR units) for a bilateral 0.75 D astigmat wearing best spherical multifocal correction (dashed line=optimal spherical correction with no astigmatism).

FIG. 5 illustrates Zemax raytracing through single vision and high add multifocal optical designs for a 4 mm pupil on model eyes with 0.75 D astigmatism (on left) and without astigmatism (on right)

### DETAILED DESCRIPTION

Aspects of the present disclosure are described in detail with reference to the drawing figures wherein like reference numerals identify similar or identical elements. It is to be understood that the disclosed aspects are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The phraseology and terminology used herein is for the purpose of description and should not be regarded as limiting. The use of “including”, “comprising”, or “having”, “containing”, “involving”, and variations thereof herein, is meant to encompass the items listed thereafter and equivalents thereof as well as additional items. In the claims, as well as in the specification above, all transitional phrases such as “comprising,” “including”, “carrying”, “having”, “containing”, “involving”, “holding”, “composed of”, and the like are to be understood to be open-ended, i.e., to mean including but not limited to. Only the transitional phrases “consisting of” and “consisting essentially of” shall be closed or semi-closed transitional phrases, respectively.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±10% of the recited value, e.g. “about 90%” may refer to the range of values from 81% to 99%.

To examine the effect during wear of contact lenses with multifocal optics, the binocular visual acuity and subjective vision for wearers with 0.75 D of uncorrected astigmatism was compared to wearers with 0 to 0.50 D of astigmatism.

Binocular VA was measured in presbyopic patients (N=384) wearing rotationally symmetric MFCLs made in senofilcon A material. Subjects with up to 0.75 D of astigmatism were included. As directed in the fit guide, many high add need subjects were fit in mini-monovision, with a mid-add lens in the dominant eye and a high-add lens in the nondominant eye. Binocular VA was measured at distance (0.25 D) and near (2.5 D) in high luminance high contrast (HLHC) and low luminance high contrast (LLHC) conditions. Subjects were categorized into two classes: (1) 0 to 0.5 D of astigmatism in both eyes [n=354], and (2) 0.75 D of astigmatism in both eyes [n=30]. Theoretical VA was determined using eye models and a neural contrast sensitivity weighted modulation transfer function that was calibrated with measured VA data available in the literature.

The model includes the age, refraction and accommodation dependence of the spherical aberration of the eye, the luminance, age, and refraction dependence of the ocular pupil, age-dependent accommodative loss, and accommodative lag. Binocular summation/inhibition was modeled considering the neural integration of monocular signals from each eye.

In clinical studies, binocular HLHC log MAR VA was −0.116±0.089, and 0.085=0.085 at distance, and 0.066±0.109 and 0.071±0.085 at near, while LLHC log MAR VA was 0.149±0.123 and 0.181±0.131 at distance, and 0.159=0.117 and 0.158±0.092 at near for groups (1) and (2), respectively. In simulations, binocular HLHC log MAR VA was 0.034 and 0.045 at distance, and 0.048 and 0.066 at near, while LLHC log MAR VA was 0.127 and 0.138 at distance, and 0.140 and 0.159 at near for groups (1) and (2), respectively.

In clinical studies, differences in average binocular VA between groups of MFCL wearers with different amounts of uncorrected astigmatism were less than 0.032 log MAR at distance, and 0.005 log MAR at near. In simulations, differences in average binocular VA between groups were less than 0.012 log MAR at distance, and 0.019 log MAR at near.

In a poster entitled “Visual performance of multifocal contact lens wearers with 0.75 D of uncorrected astigmatism” the entirety of which is incorporated herein by reference and is included as Appendix A attached hereto (hereinafter referred to as “clinical study” or “the study”).

The toric aspect of this contact lens is discussed in greater detail in U.S. Pat. No. 6,939,005, the entire contents of which are hereby incorporated by reference herein.

The multifocal aspect of this contact lens is discussed in greater detail in U.S. Pat. Nos. 7,753,521 and 8,992,012, the entire contents of which are hereby incorporated by reference herein.

The compounds discussed in U.S. Patent Application Publication No. 2024/0383865 A1, including paragraph [0149], the entire contents of which are hereby incorporated by reference herein, are an example of the materials that can be used in the contact lens of this disclosure for use as a High-Energy Visible (HEV) light filter.

The compounds discussed in U.S. patent application Ser. No. 17/552,640, filed Dec. 16, 2021, and its relations are an example of the materials that can be used in the contact lens of this disclosure for use as a High-Energy Visible (HEV) light filter. The entire contents of which are hereby incorporated by reference herein.

Further to the above, participant-level data from five clinical trials were pooled to characterize the performance of rotationally symmetric multifocal contact lenses made in senofilcon A material after 1-week of lens wear. All five clinical trials had similar eligibility criteria, dispensed the same type of lenses, and measured the same efficacy endpoints of binocular VA and subjective vision. The participants were in the age range from 40 to 70 years, had spherical equivalent refractions from −5.75 to +3.75 D, cylinder refractions from 0 to −0.75 DC, and near add requirements from +0.75 to +2.50 D. If participants were in more than one of the five studies, any repeated data was not included.

The contact lens utilized was a simultaneous vision multifocal design with three ADD powers (Low, Mid, High). As directed in a fit guide, patients with higher near ADD requirement (+2.00 D or more) were initially fit with a mid-ADD lens in the dominant eye and a high-ADD lens in the non-dominant eye, then distance and near vision could be optimized via changes in sphere or add power. Binocular visual acuity was measured at distance (4 m), intermediate (64 cm), and near (40 cm) in high luminance high contrast (HLHC) and low luminance high contrast (LLHC) conditions. Participants were categorized into a low cylinder group (0 to 0.50 D of astigmatism in both eyes, n=354), and a higher cylinder group (0.75 D of astigmatism in both eyes, n=30), while those with low cylinder in one eye and 0.75 D astigmatism in the other eye were not included. Of the 354 participants in the low cylinder group, 206 (or 58%) had a 0.00 D cylinder refraction in at least one eye, while 62 (or 17%) had a 0.50 D cylinder refraction in both eyes. Table 1 below provides the distribution of Patient Eyes by refractive cylinder.

TABLE 1

| | | | | Subjects with 0.75 |
|---|---|---|---|---|
| | Subjects with 0 to | | | in DC refraction |
| | 0.50 DC refraction | | | both eyes |
| | in both eyes (n = 354) | | | (n = 30) |
| Cylinder (D) | 0.00 | −0.25 | −0.50 | −0.75 |
| Number | 302 | 162 | 244 | 60 |
| of Eyes | | | | |

A theoretical visual acuity was determined using eye models and a neural contrast sensitivity weighted modulation transfer function (wMTF) that was calibrated with measured visual acuity data available in the literature. To represent the low cylinder group (0 to 0.50 D astigmatism), a model eye with 0.25 D astigmatism was used. The model included age, refraction and accommodation dependence of the spherical aberration of the eye, the luminance, age, and refraction dependence of the ocular pupil, age-dependent accommodative loss, and accommodative lag. Binocular summation/inhibition was modeled considering the neural integration of monocular signals from each eye.

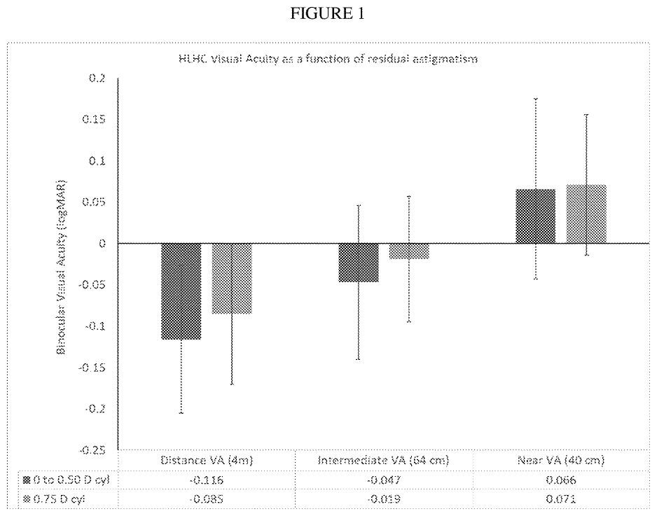

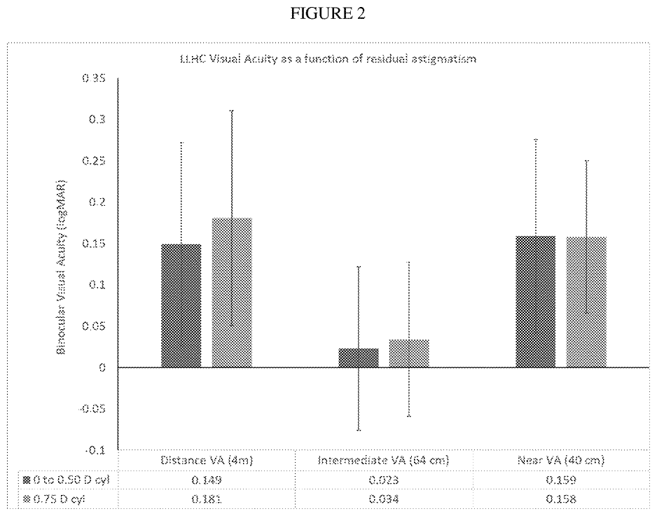

The results of the study determined that the average±standard deviation (SD) of binocular HLHC log MAR VA for patients in the low cylinder group was −0.116±0.0893 at distance and 0.066±0.1088 at near (see FIG. 1). For participants in the higher cylinder group, the average±(SD) was 0.085±0.0851 at distance, and 0.071±0.0845 at near. For binocular LLHC log MAR VA average±SD was 0.149±0.1230 and 0.181=0.1310 at distance, and 0.159±0.1174 and 0.158±0.0916 at near for the low and higher cylinder groups, respectively (see FIG. 2).

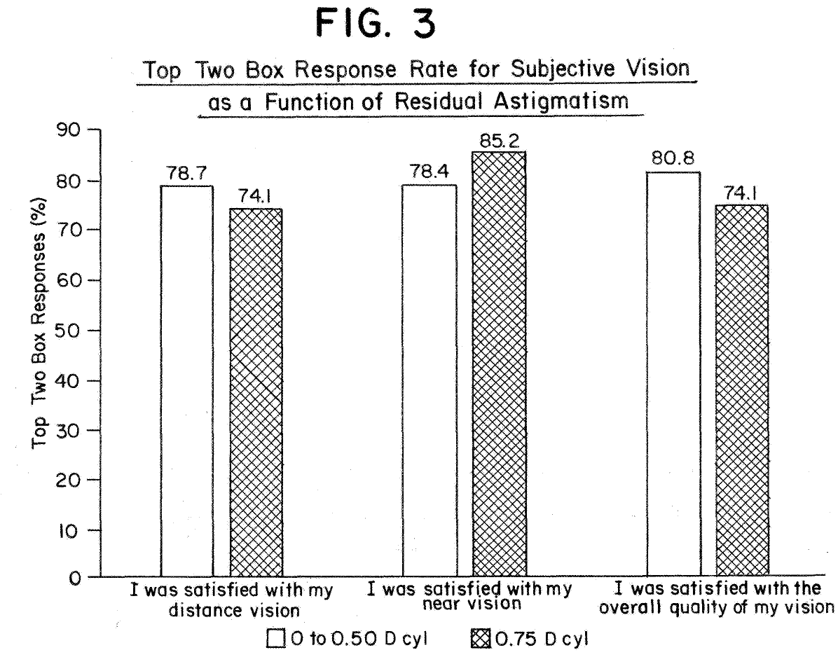

In addition to 0.75 D of uncorrected astigmatism having a limited effect on visual acuity for multifocal contact lens wearers, there were also relatively small differences found between the groups for subjective vision questionnaire results (see FIG. 3).

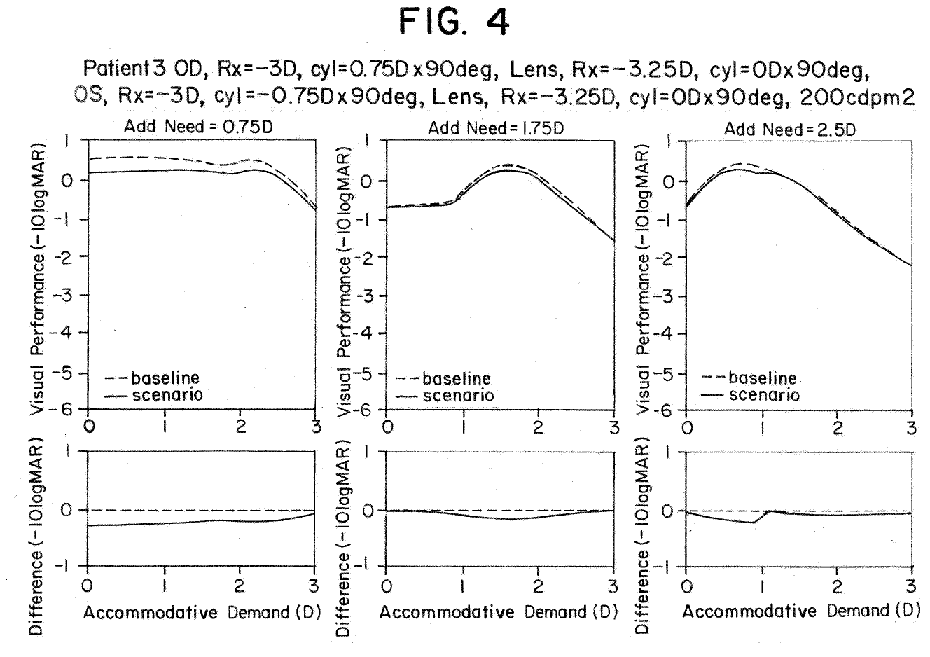

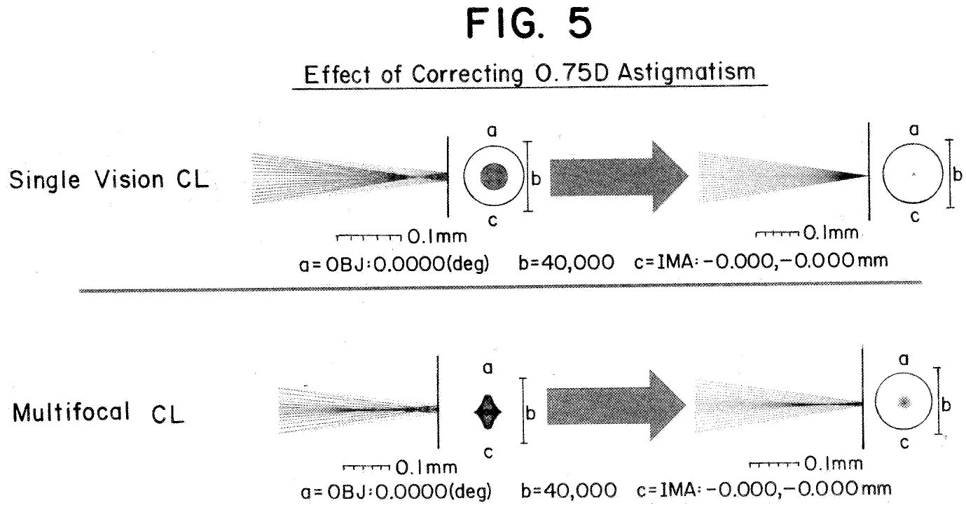

Based on the results from the wMTF, (see FIG. 4), the predicted binocular HLHC log MAR VA was 0.034 and 0.045 at distance, and 0.048 and 0.066 at near, while LLHC log MAR VA was 0.127 and 0.138 at distance, and 0.140 and 0.159 at near for low cylinder (0.25 DC) and higher cylinder (0.75 DC) models, respectively. An illustration of the extended depth of focus effect for a multifocal contact lens on eyes with and without astigmatism in shown in FIG. 5.

In clinical trials of multifocal contact lens wearers, the difference in average binocular distance visual acuity between a high cylinder (0.75 DC) group of participants and a low cylinder (0 to 0.50 DC) group was +0.031 log MAR in high luminance, and +0.032 log MAR in low luminance conditions. At near, the differences between these same groups were +0.005 log MAR in high luminance, and −0.001 log MAR in low luminance conditions. There was also a relatively small difference between the high and low cylinder groups in terms of their responses to subjective quality of vision questions. In simulations, differences in predicted binocular VA between the groups, using the average simulated acuity from low, mid and high adds, were less than 0.012 log MAR at distance, and 0.019 log MAR at near. These results suggest that the benefit of correcting 0.75 D of astigmatism for wearers of multifocal contact lenses is more limited than it is for single vision lens wearers.

Note that in eye prescriptions, both positive and negative cylinders are used to correct astigmatism. The difference lies in how the prescription is mathematically expressed, not in the final correction itself. A negative cylinder is often used in prescriptions for eyeglasses, while a positive cylinder is more common in surgical planning. When working in minus cylinder format, the −1.00 D cylinder lens would cover refractive cylinder from −0.75 to −1.75 D. When working in plus cylinder format, the +1.00 D cylinder lens would cover refractive cylinder from +0.75 to +1.75 D.

The prior art typically corrects astigmatism for wearers of multifocal contact lenses by fitting/providing multifocal contact lenses having a cylinder power ranging 0.50 D steps, starting at 0.75 D. As an example, lens can be fitted at 0.75 D, 1.25 D, 1.75 D, etc. However, that requires both the manufacturer and optometrists/ophthalmologists to produce and stock a wide range contact lenses. Examples of the present invention reduce, sometime significantly, the number of contact lenses needed to treat the patient population. Here, the patients in range between 0.75 D and 1.75 D of cylinder power needed to correct their astigmatism can be treated using a single multifocal toric contact lens at 1.00 D in lieu of two or three different cylinder power lenses to try and fit the patient. This simplifies time and ease of patient fitment and reduces inventory. For patients requiring cylinder power correction below 0.75 D, a separate lens can be fitted. Additionally, for patients requiring cylinder power correction above 1.75 D, a third multifocal toric contact lens can be fitted. The third lens may correct up to 2.50 D.

The following are exemplary aspects of the disclosure.

Aspect 1. A method of treating a patient within a patient population having presbyopia and astigmatism the method comprising:
identifying a spherical power and a cylinder power refraction of a patient within the patient population;
applying a vertex correction to a spherical power and a cylinder power of the multifocal toric lens; and
providing the multifocal toric contact lens to the patient within the patient population, wherein the magnitude of the patient's cylinder refraction is within the range from approximately 0.25 D less than the cylinder power of the multifocal toric contact lens, to approximately 0.75 D more than the cylinder power of the multifocal toric contact lens.

Aspect 2. The method of aspect 1, wherein the cylinder power of the multifocal toric contact lens is 0.75 D.

Aspect 3. The method of aspect 1, wherein the cylinder power of the multifocal toric contact lens is 1.00 D.

Aspect 4. The method of aspect 1, wherein the cylinder power of the multifocal toric contact lens is 1.25 D.

Aspect 5. The method of aspect 1, wherein the cylinder power of the multifocal toric contact lens is 1.50 D.

Aspect 6. The method of aspect 1, wherein the cylinder power of the multifocal toric contact lens is 1.75 D.

Aspect 7. The method of aspect 1, wherein the cylinder power of the multifocal toric contact lens is 2.00 D.

Aspect 8. The method of any of aspects 1-7, further comprising providing the patient with a second multifocal lens without cylindrical power for patients having a cylinder refraction of approximately less than 0.75 D.

Aspect 9. The method of aspect 8, wherein approximately 92.3% of the presbyopic patient population may be fit with a pair of the multifocal toric contact lens, or a pair of the second multifocal lens, or a combination of the multifocal toric contact lens and the second multifocal lens.

Aspect 10. The method of any of aspects 1-7, further comprising providing the patient with a second multifocal toric contact lens having approximately a 1.75 D cylinder correction for astigmatism for patients having cylinder refraction of approximately greater than or equal to 1.50 D to approximately 2.5 D.

Aspect 11. The method of aspect 10, wherein greater than 92.3% of the patient population are provided with one of the multifocal toric contact lens, the second multifocal lens, or the second multifocal toric contact lens.

Aspect 12. The method of any of aspects 1-7, further comprising providing the patient with a second multifocal toric contact lens having approximately a 2.00 D cylinder correction for astigmatism for patients having cylinder refraction of approximately greater than or equal to 1.75 D to approximately 2.75 D.

Aspect 13. The method of aspect 12, wherein greater than 92.3% of the patient population are provided with a pair of the multifocal toric contact lens, or a pair of the second multifocal lens, or a combination of the multifocal toric contact lens and the second multifocal lens.

Aspect 14. The method of aspect 1, wherein the cylinder power of the multifocal toric contact lens is 2.25 D.

Aspect 15. The method of aspect 1, wherein the cylinder power of the multifocal toric contact lens is 2.50 D.

Aspect 16. The method of aspect 1, wherein the cylinder power of the multifocal toric contact lens is 2.75 D.

Aspect 17. The method of aspect 1, wherein the cylinder power of the multifocal toric contact lens is 3.00 D.

Aspect 18. A method of treating a patient population with presbyopia and having astigmatism between 0.5 D and 1.75 D, with a multifocal toric lens having approximately a 1.0 D cylinder correction, the method comprising:
determining a sphero-cylindrical refraction of a patient;
applying a vertex correction to a sphere and a cylinder power to the lens; and
fitting the patient with a first multifocal lens for astigmatism for patients having a cylinder refraction of approximately greater than or equal to 0.75 D to approximately 1.75 D.

Aspect 19. The method of aspect 18, wherein the fitting the patient with the first multifocal lens is for patients having cylinder refraction of approximately 1.00 D to approximately 1.75 D.

Aspect 20. The method of aspect 18, wherein the fitting the patient with the first multifocal lens includes adding a −0.25 D to a sphere of the first multifocal lens for patients having cylinder refraction of 1.50 D to 1.75 D.

Aspect 21. The method of aspect 18, wherein the determining a sphero-cylindrical refraction of a patient is conducted in ambient light.

Aspect 22. The method of aspect 18, wherein the applying a vertex correction is achieved using a digital fitting calculator.

Aspect 23. The method of aspect 18, further comprising fitting the patient with a second multifocal lens for patients having a cylinder refraction of approximately less than 0.75 D.

Aspect 24. The method of aspect 23, wherein the second multifocal lens comprises no cylinder power correction.

Aspect 25. The method of aspect 23, wherein approximately 92.3% of the patient population are fitted with one of the first lens and the second lens.

Aspect 26. A method of treating a patient population with presbyopia and having astigmatism between 0.75 D and 2.5 D, with a multifocal toric lens, the method comprising:
determining a sphero-cylindrical refraction of a patient;
applying a vertex correction to a sphere and a cylinder power to the lens; and
fitting the patient with a first multifocal lens having a 1.0 D cylinder correction for astigmatism for patients having a cylinder refraction of approximately greater than or equal to 0.75 D to approximately 1.75 D; and
fitting the patient with a third multifocal lens having approximately a 1.75 D cylinder correction for astigmatism for patients having cylinder refraction of approximately greater than or equal to 1.75 D to approximately 2.5 D.

Aspect 27. The method of aspect 26, wherein the fitting the patient with the first multifocal lens is for patients having cylinder refraction of approximately 1.00 D to approximately 1.75 D.

Aspect 28. The method of aspect 26, wherein the fitting the patient with the first multifocal lens includes adding a −0.25 D to a sphere of the first multifocal lens for patients having cylinder refraction of 1.50 D to 1.75 D.

Aspect 29. The method of aspect 26, wherein the determining a sphero-cylindrical refraction of a patient is conducted in ambient light.

Aspect 30. The method of aspect 26, wherein the applying a vertex correction is achieved using a digital fitting calculator.

Aspect 31. The method of aspect 26, further comprising fitting the patient with a second multifocal lens for patients having a cylinder refraction of approximately less than 0.75 D.

Aspect 32. The method of aspect 28, wherein the second multifocal lens comprises no cylinder power correction.

Aspect 33. The method of aspect 28, wherein greater than 92.3% of the patient population are fitted with one of the first lens, the second lens and the third lens.

Aspect 34. A method of treating a patient population with presbyopia and having astigmatism between 0.75 D and 2.75 D, with a multifocal toric lens, the method comprising:
determining a sphero-cylindrical refraction of a patient;
applying a vertex correction to a sphere and a cylinder power to the lens; and
fitting the patient with a first multifocal lens having a 1.0 D cylinder correction for astigmatism for patients having a cylinder refraction of approximately greater than or equal to 0.75 D to approximately 1.75 D; and
fitting the patient with a third multifocal lens having approximately a 2.0 D cylinder correction for astigmatism for patients having cylinder refraction of approximately greater than or equal to 1.75 D to approximately 2.75 D.

Aspect 35. The method of aspect 34, wherein the fitting the patient with the first multifocal lens is for patients having cylinder refraction of approximately 1.00 D to approximately 1.75 D.

Aspect 36. The method of aspect 34, wherein the fitting the patient with the first multifocal lens includes adding a −0.25 D to a sphere of the first multifocal lens for patients having cylinder refraction of 1.50 D to 1.75 D.

Aspect 37. The method of aspect 35, wherein the determining a sphero-cylindrical refraction of a patient is conducted in ambient light.

Aspect 38. The method of aspect 34, wherein the applying a vertex correction is achieved using a digital fitting calculator.

Aspect 39. The method of aspect 34, further comprising fitting the patient with a second multifocal lens for patients having a cylinder refraction of approximately less than 0.75 D.

Aspect 40. The method of aspect 36, wherein greater than 92.3% of the patient population are fitted with one of the first lens, the second lens and the third lens.

Aspect 41. The method of aspect 39, wherein the second multifocal lens comprises no cylinder power correction.

Aspect 42. A method of treating a patient population with presbyopia and having astigmatism between 0.5 D and 2.75 D, with a multifocal lens, the method comprising:
determining a sphero-cylindrical refraction of a patient;
applying a vertex correction to a sphere and a cylinder power to the lens; and
fitting the patient with a multifocal lens, comprising only of the steps of:
fitting the patient with a first multifocal toric lens having a 1.0 D cylinder correction for astigmatism for patients having a cylinder power of approximately greater than or equal to 0.75 D to approximately 1.75 D; and fitting the patient with a second multifocal lens for patients having a cylinder refraction of approximately less than 0.75 D.

Aspect 43. The method of aspect 42, further comprising fitting the patient with a third multifocal lens having at least one of an approximately 1.75 D or an approximately 2.0 D cylinder correction for astigmatism for patients having cylinder refraction of approximately greater than or equal to 1.75 D to approximately 2.75 D.

Having shown and described exemplary embodiments of the subject matter contained herein, further adaptations of the methods, aspects and systems described herein may be accomplished by appropriate modifications without departing from the scope of the claims. In addition, where methods and steps described above indicate certain events occurring in certain order, it is intended that certain steps do not have to be performed in the order described but, in any order, as long as the steps allow the embodiments to function for their intended purposes. Therefore, to the extent there are variations of the disclosure, which are within the spirit of the disclosure or equivalent to the disclosures found in the claims, it is the intent that this patent will cover those variations as well. Some such modifications should be apparent to those skilled in the art. For instance, the examples, embodiments, geometrics, materials, dimensions, ratios, steps, and the like discussed above are illustrative. Accordingly, the claims should not be limited to the specific details of structure and operation set forth in the written description and drawings.

1. A method of treating a patient within a patient population having presbyopia and astigmatism, the method comprising:
identifying a spherical power and a cylinder power refraction of a patient within the patient population;
applying a vertex correction to a spherical power and a cylinder power of the multifocal toric lens; and
providing the multifocal toric contact lens to the patient within the patient population, wherein the magnitude of the patient's cylinder refraction is within the range from approximately 0.25 D less than the cylinder power of the multifocal toric contact lens, to approximately 0.75 D more than the cylinder power of the multifocal toric contact lens.

2. The method of claim 1, wherein the cylinder power of the multifocal toric contact lens is 0.75 D.

3. The method of claim 1, wherein the cylinder power of the multifocal toric contact lens is 1.00 D.

4. The method of claim 1, wherein the cylinder power of the multifocal toric contact lens is 1.25 D.

5. The method of claim 1, wherein the cylinder power of the multifocal toric contact lens is 1.50 D.

6. The method of claim 1, wherein the cylinder power of the multifocal toric contact lens is 1.75 D.

7. The method of claim 1, wherein the cylinder power of the multifocal toric contact lens is 2.00 D.

8. The method of claim 1, further comprising providing the patient with a second multifocal lens without cylindrical power for patients having a cylinder refraction of approximately less than 0.75 D.

9. The method of claim 8, wherein approximately 92.3% of the presbyopic patient population are fit with a pair of the multifocal toric contact lens, or a pair of the second multifocal lens, or a combination of the multifocal toric contact lens and the second multifocal lens.

10. The method of claim 1, further comprising providing the patient with a second multifocal toric contact lens having approximately a 1.75 D cylinder correction for astigmatism for patients having cylinder refraction of approximately greater than or equal to 1.50 D to approximately 2.5 D.

11. The method of claim 10, wherein greater than 92.3% of the patient population are provided with one of the multifocal toric contact lens, the second multifocal lens, or the second multifocal toric contact lens.

12. The method of claim 1, further comprising providing the patient with a second multifocal toric contact lens having approximately a 2.00 D cylinder correction for astigmatism for patients having cylinder refraction of approximately greater than or equal to 1.75 D to approximately 2.75 D.

13. The method of claim 12, wherein greater than 92.3% of the patient population are provided with a pair of the multifocal toric contact lens, or a pair of the second multifocal lens, or a combination of the multifocal toric contact lens and the second multifocal lens.

14. The method of claim 1, wherein the cylinder power of the multifocal toric contact lens is 2.25 D.

15. The method of claim 1, wherein the cylinder power of the multifocal toric contact lens is 2.50 D.

16. The method of claim 1, wherein the cylinder power of the multifocal toric contact lens is 2.75 D.

17. The method of claim 1, wherein the cylinder power of the multifocal toric contact lens is 3.00 D.
